(19) United States
(12) Patent Application Publication
(10) Pub. No.: US 2017/0171692 A1
(43) Pub. Date: Jun. 15, 2017

(54) SENSOR NODE, CONTROLLER NODE, SENSOR NETWORK SYSTEM, AND OPERATION METHOD THEREOF

(71) Applicant: ROHM CO., LTD., Ukyo-Ku (JP)

(72) Inventor: Toshikuni SHINOHARA, Ukyo-Ku (JP)

(21) Appl. No.: 15/371,519

(22) Filed: Dec. 7, 2016

(30) Foreign Application Priority Data
Dec. 10, 2015 (JP) 2015-240915

(51) Int. Cl. H04W 4/00; H04Q 9/00

(52) U.S. Cl. CPC H04W 4/005; H04Q 9/00; H04Q 2209/40; H04Q 2209/82

(57) ABSTRACT

A sensor node includes: a sensor part configured to sense information from a sensor target; a calculation part configured to digitize at least one data of a portion or all of the sensed sensor information and calculate the digitized data to abstracted data indicating a quantity of state; and an internal communication part configured to transmit the abstracted data to a controller node via a network.

### CROSS-REFERENCE TO RELATED APPLICATION(S)

This application is based upon and claims the benefit of priority from Japanese Patent Application No. 2015-240915, filed on Dec. 10, 2015, the entire contents of which are incorporated herein by reference.

### TECHNICAL FIELD

The present disclosure relates to a sensor node, a controller node, a sensor network system, and an operation method thereof.

### BACKGROUND

Recently, compact wireless function-equipped sensor terminals (also referred to as a “sensor node communication terminal” or simply a “sensor node”) incorporating a power source have been developed. Such a sensor node is installed in plurality in, for example, outdoor constructions (bridges, roads, railroads, buildings, etc.), and used to measure and analyze environment information including various physical quantities such as temperature, humidity, distortion quantity, and the like.

In an application, such a sensor node is introduced to structures of social infrastructure to perform sampling every day so as to monitor a physical condition of the infrastructure. That is, various wireless sensor network systems in which measurement data transmitted from the plurality of sensor nodes is received by and stored in a host communication terminal and a state of a construction or the like is automatically measured and monitored based on the measurement data have been proposed.

As one example of such sensor network systems, a sensor network system in which a plurality of sensors (or sensor nodes) such as a smart sensor, a sensor fusion and the like interwork with each other to perform a complex and perceptual, or complex or perceptual decision has been developed. As decision circuits that perform a complex/perceptual decision, a machine learning decision circuit based on an artificial intelligence or the like is employed in many cases.

In general, however, since the sensor network systems are limited in resources such as an installable arithmetic device, a memory, and the like in many cases, it was necessary to separately install a dedicated circuit or computer in order to perform a complex/perceptual decision.

In currently used sensors, correlation between sensors is commonly used, and generally, it is difficult to increase a decision accuracy regarding, in particular, abnormality.

For example, there is known a method of integrally determining output results from a plurality of sensors by a perception mechanism. In this case, a perception database is established through learning based on time-series data. Thus, it is inappropriate to recognize a movement (for example, a sequence operation by a sequencer or the like) that systematically changes in time series, and a decision is made based on approximate data depending on each situation. In particular, it is difficult to increase sensing ability for detecting a sequential abnormality in a system.

Also, there is known a method of diagnosing a plant based on correlation of a plurality of sensors. However, since a decision is made by the correlation between the plurality of sensors, the time-series information may be lost. Moreover, signals having no correlation may not be processed.

Further, since the aforementioned two methods commonly require a large quantity of arithmetic operation to perform a leaning and calculate correlation, these methods are not suitable for a small sensor network system that is limited in resources in terms of architecture.

In addition, there is known a technique of determining abnormality based on time-series data. This technique, however, requires a large quantity of memory to store decision condition data and model data and also requires a large quantity of arithmetic operation to determine similarity with respect to the model data, consuming a considerable amount of CPU power.

### SUMMARY

The present disclosure provides some embodiments of a sensor node, a controller node, a sensor network system, and an operation method thereof, which are capable of easily and accurately determining abnormality in a time-series event, by using an algorithm with a small amount of calculation, in a sensor network system having a plurality of sensors such as a smart sensor and a sensor fusion.

According to one embodiment of the present disclosure, there is provided a sensor node, including: a sensor part configured to sense information from a sensor target; a calculation part configured to digitize at least one data of a portion or all of the sensed sensor information and calculate the digitized data to abstracted data indicating a quantity of state; and an internal communication part configured to transmit the abstracted data to a controller node via a network.

According to another embodiment of the present disclosure, there is provided a controller node, including: a memory part configured to store vector data in an initial state or normal state of a sensor target in advance; an internal communication part configured to receive abstracted data, which is obtained by abstracting sensing data from the sensor target and individually transmitted from a plurality of sensor nodes, via a network; and a calculation part configured to determine a state of the sensor target by converting the received abstracted data into vector data and performing comparison and calculation on the converted vector data with the vector data in the initial state or normal state stored in the memory part.

According to still another embodiment of the present disclosure, there is provided a sensor network system includes a plurality of sensor nodes and a controller node. Each of the plurality of sensor nodes includes: a sensor part configured to sense information from a sensor target; a calculation part configured to digitize at least one data of a portion or all of the sensed sensor information and calculate the digitized data to abstracted data indicating a quantity of state; and an internal communication part configured to transmit the abstracted data to the controller node via a network. The controller node includes: a memory part configured to store vector data in an initial state or normal state of the sensor target in advance; an internal communication part configured to receive the abstracted data individually transmitted from the plurality of sensor nodes via the network; and a calculation part configured to determine a state of the sensor target by converting the received abstracted data into vector data and performing comparison and calculation on the converted vector data with the vector data in the initial state or normal state stored in the memory part.

According to still another embodiment of the present disclosure, there is provided a method of operating a sensor network system, including: at a plurality of sensor nodes, sensing sensor information from a sensor target; at the plurality of sensor nodes, digitizing at least one data of a portion or all of the sensed sensor information and calculating the digitized data to abstracted data indicating a quantity of state; at the plurality of sensor nodes, transmitting the abstracted data to a controller node via a network; at the controller node, receiving the abstracted data individually transmitted from the plurality of sensor nodes via the network; and at the controller node, determining a state of the sensor target by converting the received abstracted data into vector data and performing comparison and calculation on the converted vector data with vector data in an initial state or normal state of the sensor target that is pre-stored in a memory part.

### BRIEF DESCRIPTION OF THE DRAWINGS

FIG. 1 is a schematic conceptual view illustrating a configuration of a sensor network system according to a comparative example.

FIG. 2 is a schematic conceptual view illustrating a configuration of a sensor network system according to an embodiment of the present disclosure.

FIG. 3 is a schematic conceptual view of modification 1 of the sensor network system according to the embodiment.

FIG. 4 is a schematic conceptual view of modification 2 of the sensor network system according to the embodiment.

FIG. 5 is a schematic block diagram illustrating a sensor node that is applicable to the sensor network system according to the embodiment.

FIG. 6 is a schematic block diagram illustrating a controller node that is applicable to the sensor network system according to the embodiment.

FIG. 7 is a schematic block diagram illustrating example 1 of connection between a sensor node and a controller node that are applicable to the sensor network system according to the embodiment.

FIG. 8 is a schematic block diagram illustrating example 2 of connection between a sensor node and a controller node that are applicable to the sensor network system according to the embodiment.

FIG. 9 is a schematic block diagram illustrating example 3 of connection between a sensor node and a controller node that are applicable to the sensor network system according to the embodiment.

FIG. 10 is a schematic flowchart illustrating process sequence example 1 of a sensor node and a controller node that are applicable to the sensor network system according to the embodiment.

FIG. 11 is a schematic flowchart illustrating process sequence example 2 of processing a sensor node and a controller node that are applicable to a sensor network system according to an embodiment.

FIG. 12 is a schematic conceptual view illustrating a configuration of a crosswalk monitoring system to which the sensor network system according to the embodiment is applicable.

FIGS. 13A and 13B are schematic views of an example of sound volume data sensed by the sensor network system illustrated in FIG. 12, in which FIG. 13A illustrates an example of time-series data of an original signal and FIG. 13B illustrates an example of data converted into a quantity of state by processing the original signal of FIG. 13A.

FIG. 14A and 14B are schematic views of an example of illumination data sensed by the sensor network system illustrated in FIG. 12, in which FIG. 14A illustrates an example of time-series data of an original signal and FIG. 14B illustrates an example of data converted into a quantity of state by processing the original signal of FIG. 14A.

FIG. 15A to 15C are schematic views of an example of angle data and acceleration data sensed in the sensor network system illustrated in FIG. 12, in which FIG. 15A illustrates an example of time-series data of an original signal of angle data, FIG. 15B illustrates an example of time-series data of an original signal of acceleration data, and FIG. 15C illustrates an example of data converted into a quantity of state by processing the original signals of FIGS. 15A and 15B.

FIG. 16 is a schematic view illustrating an example of displaying the data converted into the quantities of state illustrated in FIGS. 13B, 14B, and 15C in an overlapping manner

FIG. 17 is a schematic view illustrating an example of displaying the data sensed by the sensor network system illustrated in FIG. 12 in an overlapping manner

FIG. 18A to 18E are schematic views illustrating an example of the data sensed by the sensor network system illustrated in FIG. 12, in which FIG. 18A illustrates an example of time-series data sensed by a sensor node, FIG. 18B illustrates an example of data obtained by abstracting the time-series data illustrated in FIG. 18A, FIG. 18C illustrates an example of pre-stored time-series vectorized data in an initial/normal state, FIG. 18D illustrates an example of data obtained by time-series vectorizing the abstracted data illustrated in FIG. 18B, and FIG. 18E illustrates an example of determination waveforms for determining a state of a sensor target based on the time-series vectorized data illustrated in FIGS. 18C and 18D.

### DETAILED DESCRIPTION

Embodiments of the present disclosure will now be described with reference to the drawings. Further, in the following description of the drawings, like or similar reference numerals are used for like or similar parts. However, it should be noted that the plane views, side views, bottom views, and cross-sectional views are schematic, and the relationships between thicknesses and planar dimensions of respective components, and the like are different from those of reality. Thus, specific thicknesses or dimensions should be determined in consideration of the following description. Also, it is understood that parts having different dimensional relationships or ratios are included among the drawings.

Further, the embodiments described below are presented to illustrate apparatuses or methods for embodying the technical concept of the present disclosure and are not intended to specify the materials, features, structures, arrangements, and the like of the components to those shown below. The embodiments may be variously modified within the scope of claims.

### COMPARATIVE EXAMPLE

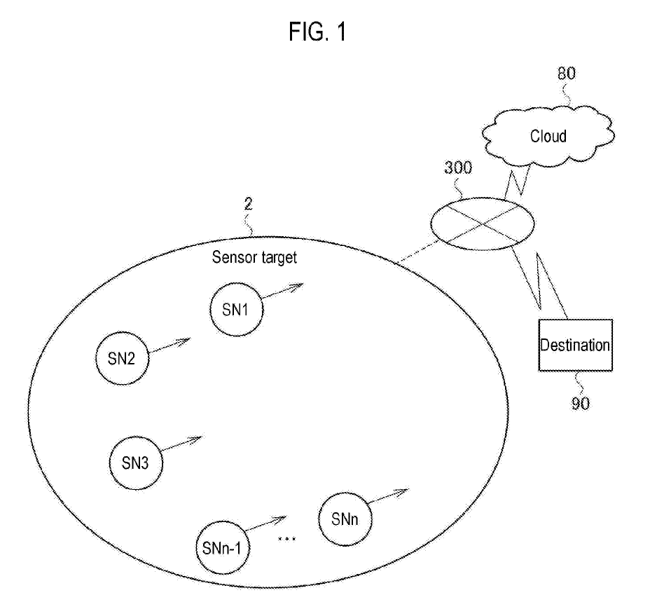

A schematic conceptual configuration of a sensor network system according to a comparative example is illustrated in FIG. 1. As illustrated in FIG. 1, the sensor network system according to the comparative example includes a sensor target 2, and a plurality of sensor nodes SN (SN1, SN2, SN3, . . . , SNn-1, and SNn) installed in the sensor target 2 and having sensor elements such as, for example, a sound, illumination, angle, acceleration, magnetism, gyro, temperature, humidity, pressure, vibration, impact, infrared ray, motion, gas, smell, and the like, and may be connected to a cloud computing system 80 via a long-range network 300 such as the Internet. In order to connect the plurality of sensor nodes SN1, SN2, SN3, . . . , SNn-1, and SNn and the cloud computing system 80 via the network 300, either or both of wired communication or wireless communication may be applicable.

The cloud computing system 80 accumulates sensor information (sensing data) periodically or aperiodically transmitted individually from the plurality of sensor nodes SN1, SN2, SN3, . . . , SNn-1, and SNn installed in the sensor target 2 in a data server (not shown), and analyzes and determines the sensor information accumulated in the data server based on an artificial intelligence or a genetic algorithm in a calculation part (not shown). A result of the analysis and determination is notified to a predetermined destination 90 through the network 300.

As described above, in the sensor network system according to the comparative example, since the sensor information individually transmitted from the plurality of sensor nodes SN1, SN2, SN3, . . . , SNn-1, and SNn are collectively accumulated, the data server requires a large memory area. Further, since the sensor information accumulated in the memory area is also analyzed and determined based on the artificial intelligence or the genetic algorithm, a large amount of calculation is required, increasing a load or a processing time of a CPU.

### (Sensor Network System According to Embodiment)

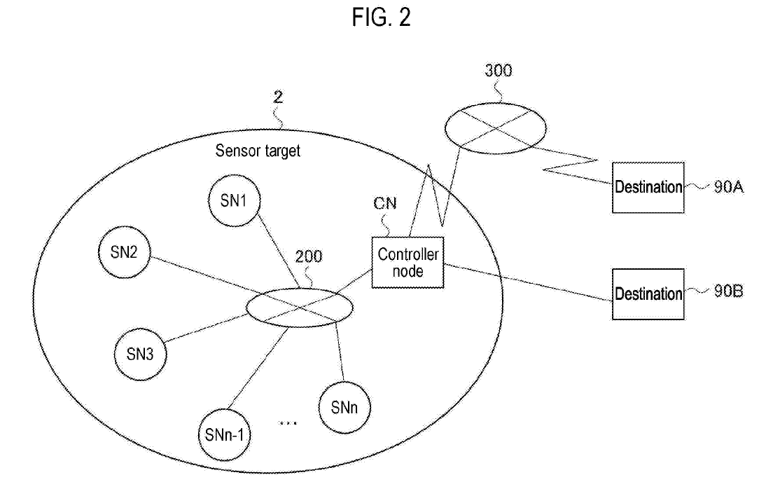

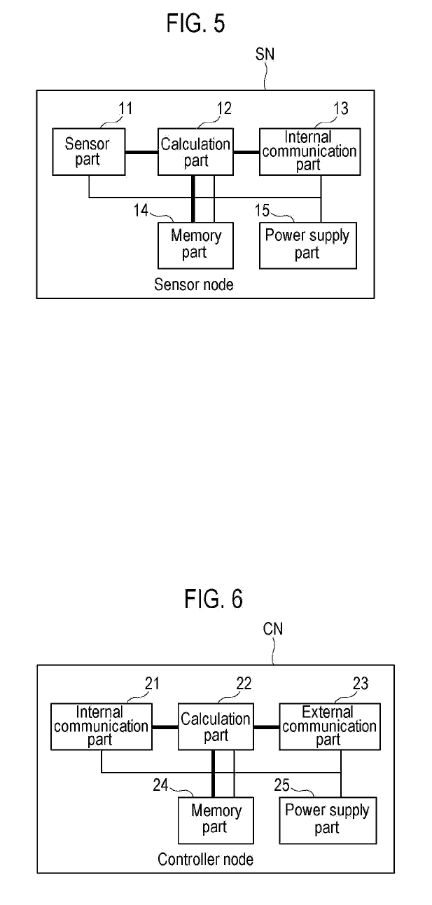

A schematic conceptual configuration of a sensor network system according to an embodiment of the present disclosure is illustrated in FIG. 2. The sensor network system according to the embodiment includes a plurality of sensor nodes SN1, SN2, SN3, . . . , SNn-1, and SNn. As illustrated in FIG. 5, each of the sensor nodes SN has a sensor part 11 for sensing information from a sensor target 2, a calculation part 12 for digitizing at least one data of a portion or all of the sensed sensor information and calculating the digitized data to abstracted data indicating a quantity of state, and an internal communication part 13 for transmitting the abstracted data to a controller node CN via a network 200. The sensor network system according to the embodiment further includes the controller node CN. As illustrated in FIG. 6, the controller node CN has a memory part 24 for storing vector data in an initial state or normal state of the sensor target 2 in advance, an internal communication part 21 for receiving abstracted data individually transmitted from the plurality of sensor nodes SN1, SN2, SN3, . . . , SNn-1, and SNn via the network 200, and a calculation part 22 for converting the received abstracted data into vector data and comparing/calculating the converted vector data with the vector data in the initial state or normal state that is stored in the memory part 24 to determine a state of the sensor target 2.

More specifically, the sensor network system according to the embodiment includes: the sensor target 2; the plurality of sensor nodes SN1, SN2, SN3, . . . , SNn-1, and SNn installed in the sensor target 2 and having sensor elements such as sound, illumination, angle, acceleration, magnetism, gyro, temperature, humidity, pressure, vibration, impact, infrared ray, motion, gas, smell, and the like; and the controller node CN for collecting sensor information periodically or aperiodically transmitted individually from each of the plurality of sensor nodes SN1, SN2, SN3, . . . , SNn-1, and SNn via the relatively short-range network 200 such as ZigBee®, Bluetooth®, Smart®, Wi-Fi®, a specific wireless smart utility network (Wi-SUN®), and the like. For the connection between the plurality of sensor nodes SN1, SN2, SN3, . . . , SNn-1, and SNn and the controller node CN via the network 200, wireless communication is generally used, but wired communication may also be applicable. That is, wired communication may be used in at least a portion of connection between the plurality of sensor nodes SN1, SN2, SN3, . . . , SNn-1, and SNn and the controller node CN via the network 200.

The Wi-SUN may be introduced into commercial facilities such as, for example, homes, or office buildings. The Wi-SUN is a wireless communication technology that allows communication by means of radio waves having a frequency of about 920 MHz called a sub-gigahertz band. For a general household purpose, the Wi-SUN may be applicable to a home area network (HAN) as a home energy management system (HEMS) network that associates an HEMS, home appliances, and the like. In the commercial facilities, the Wi-SUN may be applicable to a building energy management system (BEMS) network that associates a BEMS, facilities, and the like.

Meanwhile, a wireless sensor system that employs a battery-less wireless technology called a self-generation type may also be applicable to the sensor network system according to the embodiment. EnOcean® is a technology that obtains an electric power through electromagnetic induction or by converting a natural energy such as sunlight into an electric energy, which is so-called a technology using energy harvesting (environment power generation), and allows wireless communication without a power source.

The sensor target 2 is, for example, any one or both of an interpersonal notification signal and a light. Here, the interpersonal notification signal includes a crosswalk or railroad signal (signal for a railroad, a crossing barrier, etc.), a road signal (a signal light or the like), an aviation signal (airplane warning light, aerodrome light, etc.), and a marine signal (a floating light, a beacon light (navigational aids), etc.). Further, the light includes a standing light, an emergency exit light, an emergency light, a street light, etc.

The interpersonal notification signal or the light is disposed in a construction such as, for example, a railroad, road, airport, port, bridge, building, or the like. Further, the interpersonal notification signal or the light is not limited to the construction and may be used in various fields such as air pollution, forest fire, wine brewing quality management, care of children who plays in the field, care of people who play a sport, detection of a smart phone, peripheral access control to a nuclear power plant or a defense facility, detection of a radioactivity level in a nuclear power plant, strength level control of electromagnetic field, recognition of a traffic jam situation such as traffic congestion, smart road, smart lighting, high-functional shopping, a noise environment map, highly efficient shipment of a ship, water quality management, waste treatment management, smart parking, golf course management, water leakage and gas leakage management, automatic driving management, effective infrastructure arrangement and management in an urban area, and a farm.

Each of the sensor nodes SN1, SN2, SN3, . . . , SNn-1, and SNn and the controller node CN have a power supply means such as a battery (for example, a pn junction type solar cell, a dye-sensitized solar cell, an organic thin film solar cell, a compound-based solar cell, an electrical double layer capacitor, a lithium ion battery, or the like) or an environment power generation device. Thus, it is not necessary to supply an electric power from outside to each of the sensor nodes SN1, SN2, SN3, . . . , SNn-1, and SNn and the controller node CN via a power line or the like, and the sensor nodes SN1, SN2, SN3, . . . , SNn-1, and SNn and the controller node CN may be autonomously operated. Thus, an autonomous decentralized sensor network system may be established by the plurality of sensor nodes SN1, SN2, SN3, . . . , SNn-1, and SNn and the controller node CN.

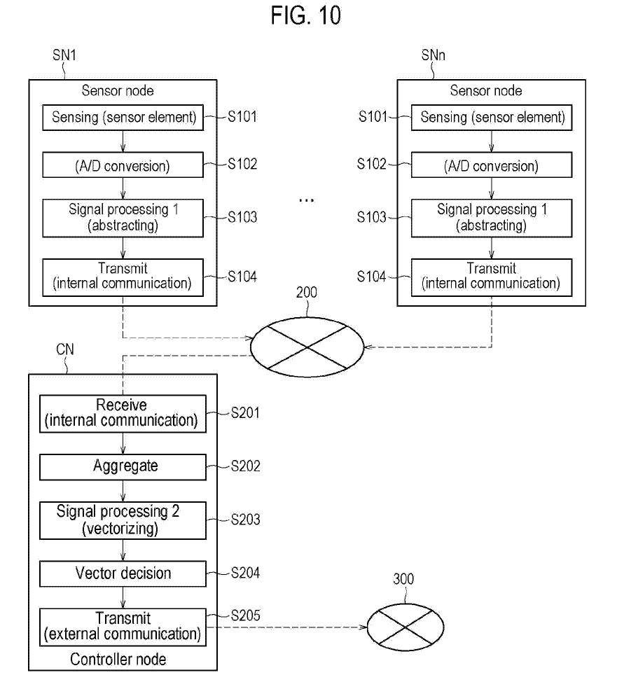

As described later (see FIG. 10), each of the sensor nodes SN1, SN2, SN3, . . . , SNn-1, and SNn senses information from the sensor target 2 (sensing: S101), filters and digitizes at least one data of a portion or all of the sensed sensor information (for example, in time series) as necessary (A/D conversion: S102), calculates the digitized data to, for example, abstracted data indicating a quantity of state (signal processing 1: S103), and transmits the abstracted data to the controller node CN via the network 200 (internal communication: S104).

Meanwhile, as described later (see FIG. 10), the controller node CN receives the abstracted data individually transmitted from the plurality of sensor nodes SN1, SN2, SN3, . . . , SNn-1, and SNn (internal communication: S201), aggregates the received abstracted data (aggregation: S202), converts the received abstracted data into vector data, for example, time-series vector data (signal processing 2: S203), compares/calculates the converted vector data by using an accumulated norm, inner product, and the like of deviation vectors to determine a state of the sensor target 2 (vector determination: S204), and notifies a predetermined destination 90A about the determined state of the sensor target 2 through a network 300 or directly notifies a predetermined destination 90B about the determined state of the sensor target 2 (external communication S205). Further, the vector determination S204 is performed by comparing and calculating the vector data in an initial state or normal state of the sensor target 2, which is pre-stored in the controller node CN at a timing such as an initial operation stage, re-starting, or regular updating, and the vector data converted in the signal processing 2 (S203). Here, as the vector data in the initial state or normal state, an average value of samplings of several times (for example, 5 times) may be used.

Further, the controller node CN may also access a cloud computing system (not shown) to upload the vector data in the initial state or normal state of the sensor target 2, the determined state of the sensor target 2, or the like to the cloud computing system or download the same from the cloud computing system.

In addition, although the details thereof will be described later, the signal processing 1 (S103) may be configured to be executed by the controller node CN, instead of being executed by each of the sensor nodes SN1, SN2, SN3, . . . , SNn-1, and SNn.

Further, vector data may be generated for each type of sensed sensor information.

In the sensor network system according to the embodiment, the time-series data collected using the plurality of sensor nodes SN1, SN2, SN3, . . . , SNn-1, and SNn may be abstracted to, for example, data indicating a quantity of state, and converted into, for example, time-series vector data. The conversion method may include standardization of a signal, function conversion, short-time peak hold/median filter, differential processing in a frequency domain or digitization or quantization by RMS or the like, situation determination based on conditional branch or a previous value, and the like.

Further, it is possible to reduce a data amount by abstracting the data collected using the sensor nodes SN1, SN2, SN3, . . . , SNn-1, and SNn.

The vector data is stored as vector data in an initial state or a normal state at a timing such as an initial operation stage, re-starting, regular updating, or the like in the controller node CN, and as necessary, calculation is performed in real time by comparing the stored vector data with newly output series (newly sensed and converted vector data). When a current value is compared from a front value of time-series data, it is possible to determine the entire time-series behavior (tendency determination). When the current value is compared with only data close to the current value, it is possible to sense sudden abnormality.

Further, by preparing a plurality of time-series vector data, a plurality of time-series data that easily react with various abnormalities may be simultaneously verified. As a vector data comparing method, accumulated norm, inner product, or the like of deviation vectors may be used, and a calculation amount thereof is remarkably small, compared with a calculation amount based on a generic algorithm or an artificial intelligence.

As mentioned above, in the sensor network system according to the embodiment having the sensor node SN having a plurality of sensors such as a smart sensor and a sensor fusion, abnormality of a time-series event may be easily and highly accurately determined through an algorithm with a small amount of calculation. Thus, it is possible to realize a sensor network system that is suitable for monitoring a movement or the like of a device by a sequencer or the like.

Thus, since a determination may be performed by a CPU, an MPU, or the like mounted in the controller node CN for controlling the sensor node SN group, an autonomous sensor network system (for example, abnormality determination system) may be easily established.

Further, in the sensor network system connected to a higher level such as a personal computer, a smart phone, a cloud computing system, or the like, a first abnormality determination can be performed by the controller node CN or the like in the sensor network system. Thus, by uploading live data to the higher level such as the cloud computing system only when necessary, for example, at the time of occurrence of abnormality or periodical or arbitrary diagnosis while avoiding data transmission in normal time, a communication burden or a calculation load at the higher level, a data capacity, and the like in normal time may be reduced.

### (Modification 1)

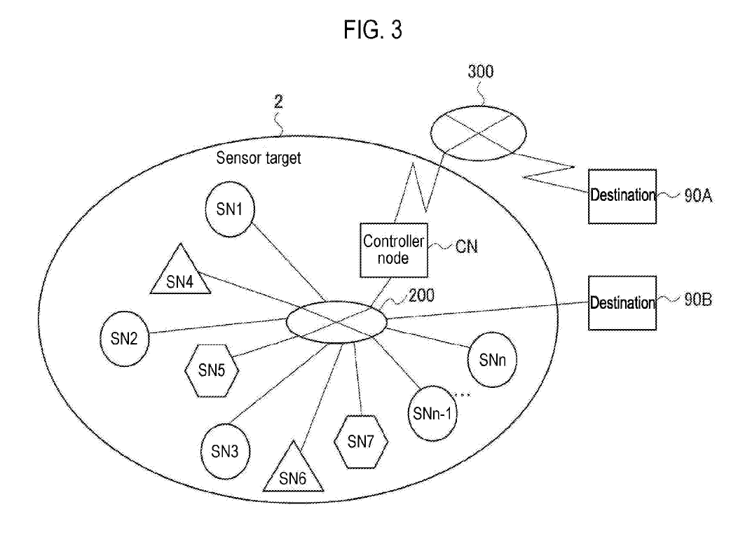

A schematic conceptual configuration of modification 1 of the sensor network system according to the embodiment is illustrated in FIG. 3.

In the sensor network system of the modification 1 according to the embodiment, a plural type of sensor nodes SN1, SN2, SN3, SN4, SN5, SN6, SN7, . . . , SNn-1, and SNn are installed in a sensor target 2.

More specifically, a first type of sensor nodes SN1, SN2, SN3, . . . , SNn-1, and SNn, a second type of sensor nodes SN4 and SN6, and a third type of sensor nodes SN5 and SN7 are installed in the sensor target 2. For example, the first type of sensor nodes SN1, SN2, SN3, . . . , SNn-1, and SNn are sound sensors (for example, Si microphone) for sensing a sound volume, the second type of sensor nodes SN4 and SN6 are photo sensors for sensing intensity of illumination, and the third type of sensor nodes SN5 and SN7 are accelerometers for sensing acceleration of an object.

Further, the type of the sensor node SN is not limited to three types and may be two types or four types. Also, for each type, a plurality of sensor nodes SN may be installed or a single sensor node SN may be installed.

Other configuration of each part is the same as that of each part of the sensor network system according to the embodiment illustrated in FIG. 2.

### (Modification 2)

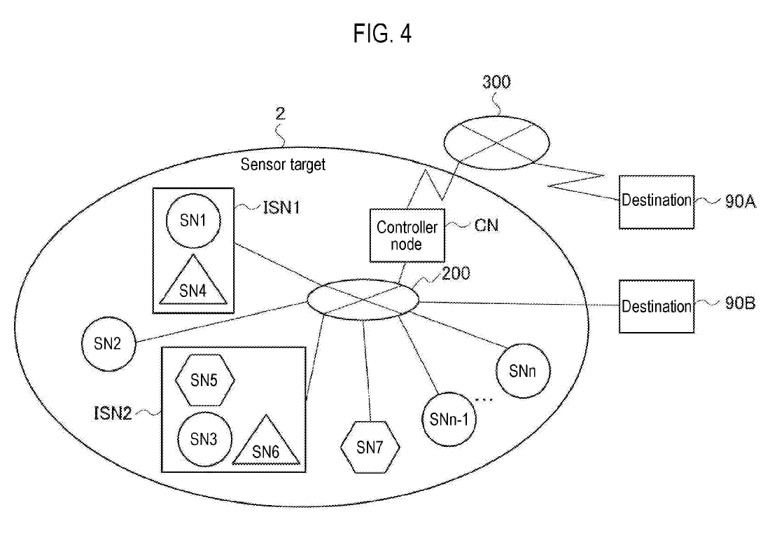

A schematic conceptual configuration of modification 2 of the sensor network system according to the embodiment is illustrated in FIG. 4.

In the sensor network system of the modification 2 according to the embodiment, a plurality of sensor nodes SN1 and SN4 are integrated in an integrated sensor node ISN1 and a plurality of sensor nodes SN3, SN5, and SN6 are integrated in an integrated sensor node ISN2.

For example, the senor nodes integrated in the integrated sensor node ISN1 include a first type of sensor node SN1 (for example, a sound sensor) and a second type of sensor node SN4 (for example, a photo sensor), and the sensor nodes integrated in the integrated sensor node ISN2 include a first type of sensor node SN3 (for example, a sound sensor), a second type of sensor node SN6 (for example, a photo sensor), and a third type of sensor node SN5 (for example, an accelerometer).

Further, the number of types of integrated sensor nodes SN is not limited to two types or three types and may be four or more types, and one type of a plurality of sensor nodes SN may be integrated. Also, a plurality of sensor nodes SN of the same type may be integrated.

Other configuration of each part is the same as that of each part of the sensor network system according to the embodiment illustrated in FIG. 2.

In addition, as illustrated in the modifications 1 and 2, it is possible to enhance the accuracy of determination by acquiring a plural type of sensing data using the plurality types of sensor nodes SN, combining the sensing data, and using a state of the sensor target 2 in determination.

### (Sensor Node)

A schematic block diagram of the sensor node SN that is applicable to the sensor network system according to the embodiment is illustrated in FIG. 5. As illustrated in FIG. 5, the sensor node SN that is applicable to the sensor network system according to the embodiment includes: a sensor part 11 for sensing information from the sensor target 2; a calculation part 12 for digitizing at least one data of a portion or all of the sensed sensor information to, for example, time-series data, and calculating the digitized data to, for example, abstracted data indicating a quantity of state; an internal communication part 13 for transmitting the abstracted data to the controller node CN via the network 200; a memory part 14 for storing the sensed sensor information or the like; and a power supply part 15 for supplying an electric power to the sensor node SN.

The sensor part 11 is a sensor element for sensing information from the sensor target 2 such as an interpersonal notification signal or a light, and for example, a sensor element for sound, illumination, angle, acceleration, magnetism, gyro, temperature, humidity, pressure, vibration, impact, infrared ray, motion, gas, or smell. The sensor part 11 may include a plural number of sensor elements, or a plural type of sensor elements, or a plural number and a plural type of sensor elements, among sensor elements for sound, illumination, angle, acceleration, magnetism, gyro, temperature, humidity, pressure, vibration, impact, infrared ray, motion, gas, and smell. Further, the abstracted data may be generated in plural types for each sensing event as described later.

The calculation part 12 is a calculation unit (a central processing part (CPU) or micro-processing unit (MPU)) for digitizing the sensor information sensed by the sensor part 11 and calculating the digitized data to abstracted data indicating a quantity of state.

The memory part 14 is a storage part for storing the sensed sensor information and the like. As the memory part 14, a storage device such as a ROM/RAM, a flash memory, a magnetic memory device (hard disk drive, a floppy® disk, etc.), an optical memory device, a magneto-optical memory device, or a non-volatile logic may be used.

The internal communication part 13 is a communication means with the controller node CN and also a communication means for transmitting the abstracted data to the controller node CN via the network 200. As the network 200, a relatively short-range wireless network means such as, for example, ZigBee®, Bluetooth®, Smart®, or Wi-SUN® may be used, but a wired network means may also be employed.

The power supply part 15 is one or a plural type of power supply means such as a battery (for example, a pn junction type solar cell, a dye-sensitized solar cell, an organic thin film solar cell, a compound-based solar cell, an electrical double layer capacitor, a lithium ion battery, or the like), an environment power generation device, and the like. By providing the power supply part 15, it is not necessary to supply an electric power to each sensor node SN from the outside via a power line, and each sensor node SN may be autonomously operated.

### (Controller Node)

A schematic block diagram of the controller node CN that is applicable to the sensor network system according to the embodiment is illustrated in FIG. 6. As illustrated in FIG. 6, the controller node CN that is applicable to the sensor network system according to the embodiment includes: a memory part 24 for storing vector data in an initial state or normal state of the sensor target 2 in advance at a timing such as an initial operation stage, re-starting, or regular updating; an internal communication part 21 for receiving abstracted data obtained by abstracting sensing data of the sensor target 2 and individually transmitted from the plurality of sensor nodes SN via the network 200; a calculation part 22 for converting at least one received abstracted data to vector data, for example, time-series vector data, and comparing/calculating the converted vector data with the vector data in the initial state or normal state stored in the memory part 24 by using accumulated norm, inner product, or the like of deviation vectors to determine a state of the sensor target 2; an external communication part 23 for notifying the predetermined destination 90A about the state of the sensor target 2 determined by the calculation part 22 via the network 300 or directly notifying the predetermined destination 90B about the state of the sensor target 2; and a power supply part 25 for supplying an electric power to the controller node CN. Further, it may be configured that the internal communication part 21 receives the sensing data before abstraction of the sensor target 2 from at least one of the plurality of sensor nodes SN and the calculation part 22 calculates the received sensing data to abstracted data indicating a quantity of state.

The internal communication part 21 is a communication means with the sensor node SN and receives abstracted data individually transmitted from the plurality of sensor nodes SN via the network 200. As the network 200, a relatively short-range wireless network means such as, for example, ZigBee®, Bluetooth®, Smart®, or Wi-SUN® may be used, but a wired network means may also be employed.

The calculation part 22 is a calculation unit (a central processing part (CPU) or micro-processing unit (MPU)) for converting the received abstracted data into, for example, time-series vector data, and comparing/calculating the converted vector data by using accumulated norm, inner product, or the like of deviation vectors to determine a state of the sensor target 2. Further, the vector data may be generated in plural types for each sensing event by each sensor node SN.

The external communication part 23 is a communication means for notifying the predetermined destination 90A about the state of the sensor target 2 determined by the calculation part 22 via the network 300 or directly notifying the predetermined destination 90B about the state of the sensor target 2. As the network 300, a long-range network means such as, for example, Bluetooth®, Wi-Fi® or the Internet may be employed.

The memory part 24 is a memory means for storing vector data in an initial state or normal state of the sensor target 2 in advance at a timing such as an initial operation stage, re-starting, or regular updating. As the memory part 14, a storage device such as a ROM/RAM, a flash memory, a magnetic memory device (hard disk drive, a floppy® disk, etc.), an optical memory device, a magneto-optical memory device, or a non-volatile logic.

The power supply part 25 is one or a plural type of power supply means such as a battery (for example, a pn junction type solar cell, a dye-sensitized solar cell, an organic thin film solar cell, a compound-based solar cell, an electrical double layer capacitor, a lithium ion battery, or the like), an environment power generation device, and the like. By providing the power supply part 25, it is not necessary to supply an electric power to the controller node CN from the outside via a power line, and the controller node CN may be autonomously operated. Power feeding may also be performed by wireless feeding or wired feeding.

### Example 1 of Connection between Sensor Node and Controller Node

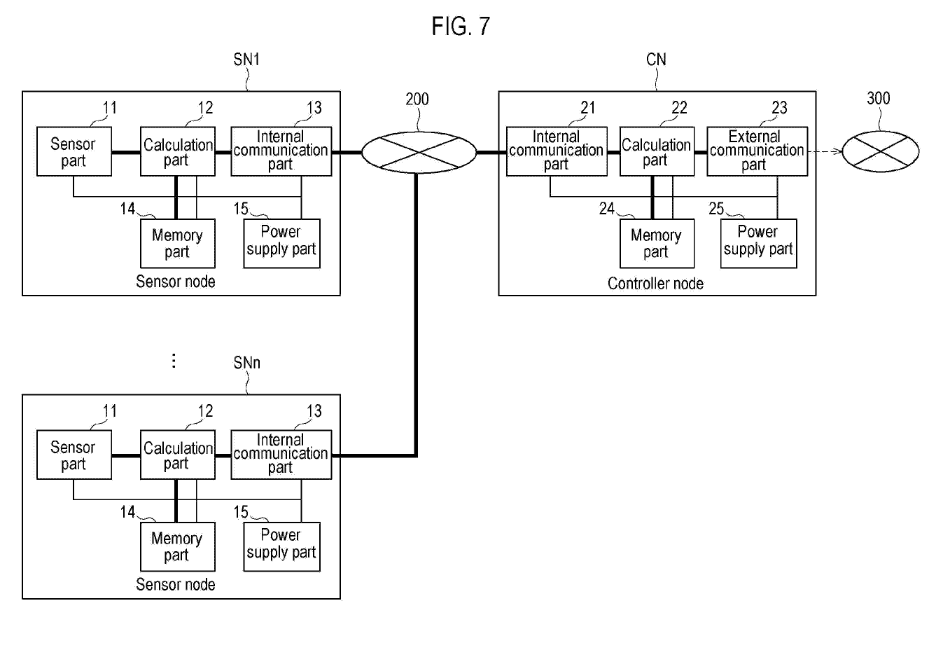

A schematic block diagram of example 1 of connection between the sensor node SN and the controller node CN that are applicable to the sensor network system according to the embodiment is illustrated in FIG. 7. The connection example 1 illustrated in FIG. 7 is an example of connecting a plural number of (or a plural type of) sensor nodes SN1, SNn to the controller node CN. In this case, the internal communication part 13 of each of the sensor nodes SN1, . . . , SNn is connected to the internal communication part 21 of the controller node CN.

Further, in FIG. 7, the thin lines connecting the blocks indicate a flow of control and the thick lines connecting the blocks indicate a flow of data.

### Example 2 of Connection between Sensor Node and Controller Node

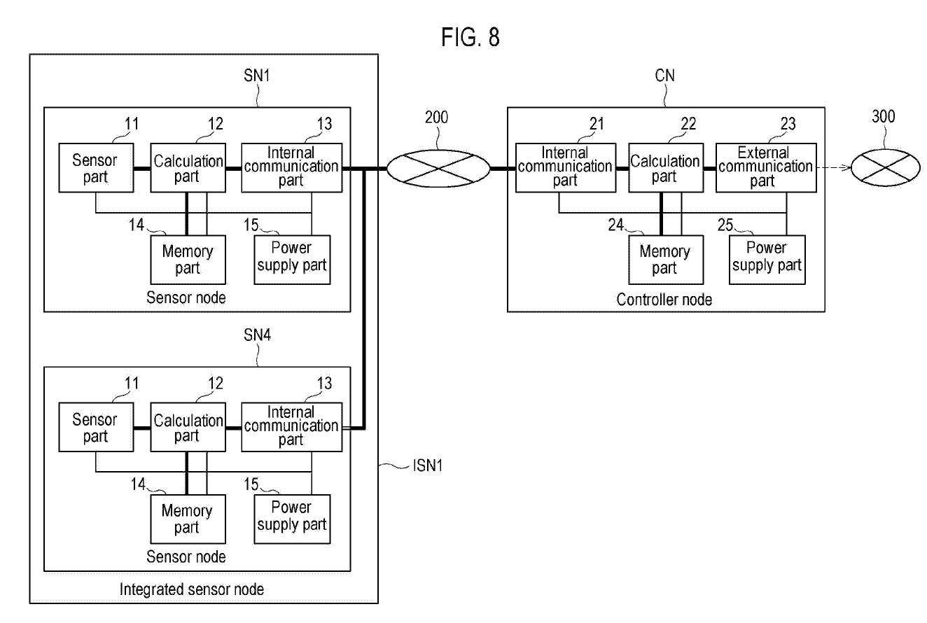

A schematic block diagram of example 2 of connection between the sensor node SN and the controller node CN that are applicable to the sensor network system according to the embodiment is illustrated in FIG. 8. The connection example 2 illustrated in FIG. 8 is an example in which an integrated sensor node ISN1 in which a plural number of (or a plural type of) sensor nodes SN1 and SN4 are integrated is connected to the controller node CN. In this case, the internal communication part 13 of each of the sensor nodes SN1, SNn in the integrated sensor node ISN1 is connected to the internal communication part 21 of the controller node CN.

Further, in FIG. 8, the thin lines connecting the blocks indicate a flow of control and the thick lines connecting the blocks indicate a flow of data.

### Example 3 of Connection between Sensor Node and Controller node

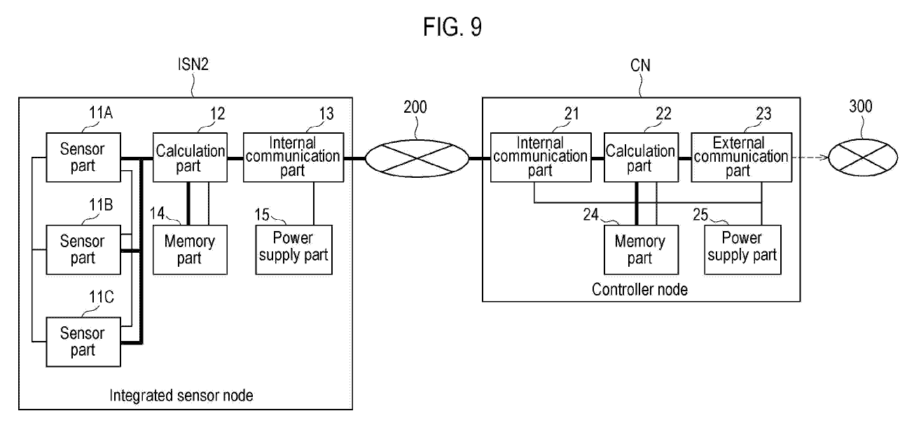

A schematic block diagram of example 3 of connection between the sensor node SN and the controller node CN that are applicable to the sensor network system according to the embodiment is illustrated in FIG. 9. In the connection example 3 illustrated in FIG. 9, sensor parts 11A, 11B, and 11C of a plural number of (or a plural type of) sensor nodes SN are integrated in an integrated sensor node ISN2, while the calculation part 12, the internal communication part 13, the memory part 14, and the power supply part 15, other than the sensor part 11, are commonly used in the integrated sensor node ISN2. The internal communication part 13 in the integrated sensor node ISN2 is connected to the internal communication part 21 of the controller node CN.

Further, in FIG. 9, the thin lines connecting the blocks indicate a flow of control and the thick lines connecting the blocks indicate a flow of data.

### Example 1 of Process Sequence Sensor Node and Controller Node

Example 1 of process sequence of the sensor node SN and the controller node CN that is applicable to the sensor network system according to the embodiment is illustrated in FIG. 10.

As illustrated in FIG. 10, the plurality of sensor nodes SN1 to SNn senses information from the sensor target 2 (sensing: S101), filters and digitizes the sensed sensor information to, for example, time-series data as necessary (A/D conversion: S102), calculates the digitized data to, for example, abstracted data indicating a quantity of state (signal processing 1: S103), and transmits the abstracted data to the controller node CN via the network 200 (internal communication: S104).

Meanwhile, the controller node CN receives abstracted data individually transmitted from the plurality of sensor nodes SN1 to SNn (internal communication: S201), aggregates the received abstracted data (aggregation: S202), converts the received abstracted data into, for example, time-series vector data (signal processing 2: S203), compares/calculates the converted vector data by using accumulated norm, inner product, or the like of deviation vectors to determine a state of the sensor target 2 (vector determination: S204), and notifies the predetermined destination 90A about the determined state of the sensor target 2 via the network 300 or directly notifies the predetermined destination 90B about the determined state of the sensor target 2 (external communication: S205). The vector determination S204 is performed by comparing and calculating vector data in an initial state or normal state of the sensor target 2 that is pre-stored in the controller node CN at a timing such as an initial operation stage, re-starting, or regular updating, and the vector data converted in the signal processing 2 (S203).

### Example 2 of Process Sequence of Sensor Node and Controller Node

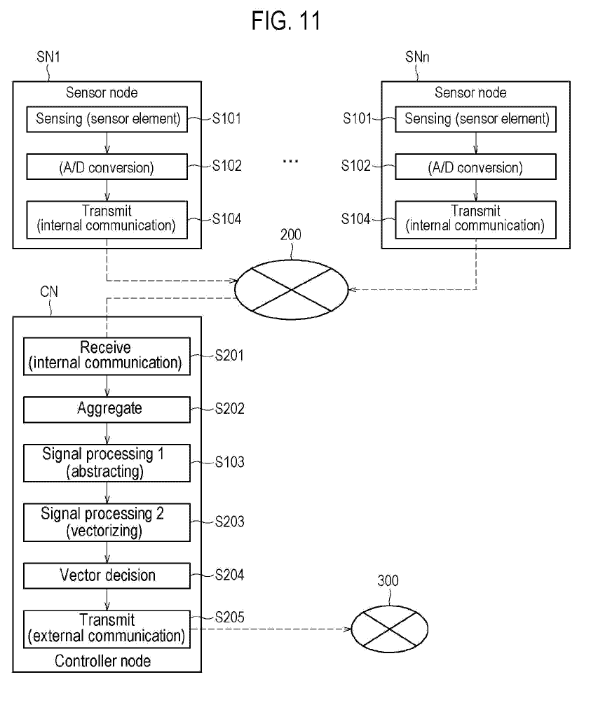

Example 2 of process sequence of the sensor node SN and the controller node CN that are applicable to the sensor network system according to the embodiment is illustrated in FIG. 11. The process sequence example 2 illustrated in FIG. 11 is different from the process sequence example 1 illustrated in FIG. 10, in that the signal processing 1 (S103), in which the data digitized in the A/D conversion (S102) by filtering as necessary is abstracted to data indicating a quantity pf state, is executed by the calculation part 22 of the controller node CN, rather than by the calculation part 12 of each of the sensor nodes SN1 to SNn.

According to the process sequence example 2 illustrated in FIG. 11, it is possible to reduce a load of the calculation part 12 of each of the sensor nodes SN1 to SNn.

### (Applications: Crosswalk Monitoring System)

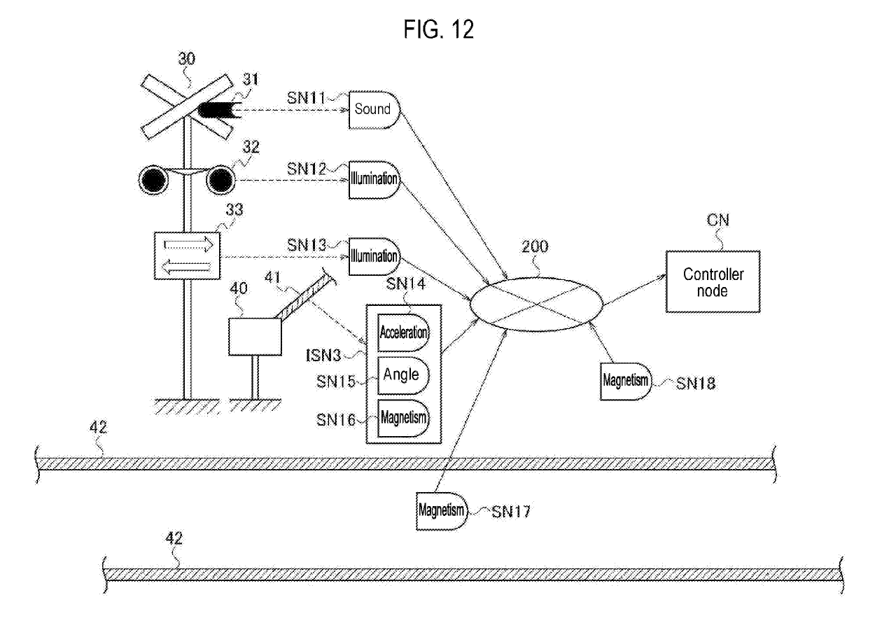

A schematic conceptual configuration of a crosswalk monitoring system to which the sensor network system according to the embodiment is applicable is illustrated in FIG. 12.

As illustrated in FIG. 12, the crosswalk monitoring system includes a crosswalk alarm 30, a crossing barrier 40, and a railroad (rail) 42, which are crosswalk facilities as the sensor target 2. The crosswalk alarm 30 has an alarm generator (speaker) 31, an alarm lamp 32, and a direction indicator 33, and the crossing barrier 40 has a crossing rod 41.

In the speaker 31, installed is a sensor node SN11 having a sound sensor (for example, an Si microphone) for sensing an alarm sound (sound volume) generated from the speaker 31. In the alarm lamp 32, installed is a sensor node SN12 having a photo sensor for sensing brightness of a red light generated by the alarm lamp 32. In the direction indicator 33, installed is a sensor node SN13 having a photo sensor for sensing intensity of illumination of light of the arrows indicating a movement direction of an approaching train.

In the crossing rod 41 for blocking a road when a train approaches, installed is an integrated sensor node ISN3 in which a sensor node SN14 having an accelerometer for sensing 3-axis acceleration of the crossing rod 41, a sensor node SN15 having an angle sensor for sensing a 3-axis angle of the crossing rod 41, and a sensor node SN16 for sensing a vehicle body or a vehicle based on a variation in a magnetic field are integrated.

Further, a sensor node SN17 having a magnetic sensor for sensing a vehicle (not shown) that passes through the railroad 42 and distortion of a magnetic field due to a vehicle body or a vehicle is installed between the rails of the railroad 42. Similarly, for example, in case of a double railroad such as upper and lower railroads, a sensor node SN18 having a magnetic sensor is installed between the rails of a different railroads 42 (not shown).

The sensor node SN installed in each part of the sensor target 2 of the crosswalk monitoring system illustrated in FIG. 12 may be appropriately installed in the vicinity of each part of the sensor target 2, inside each part of the sensor target 2, or outside each part of the sensor target 2. For example, the sensor node SN12 installed in the alarm lamp 32 may be installed in a housing of the alarm lamp 32 such as the inner side of a shade or a cover thereof.

An example of the sensor nodes SN installed in each part of the sensor target 2 of the crosswalk monitoring system employing the sensor network system according to the embodiment, and a sensing event by each sensor node SN is illustrated in Table 1. A sensor element (sensor part 11) of each of the sensor nodes SN11 to SN18, which is capable of measuring a plurality of physical quantities, may be included (integrated) in one node. For example, in the example of the aforementioned crossing rod 41, the integrated sensor node ISN3 integrated by combining a 3-axis acceleration and a 3-axis angle is installed in the crossing rod 41.

TABLE 1

| Sensor target | Sensor configuration | Sensing event |
|---|---|---|
| Alarm generator (speaker) | Power-equipped Si | Alarm sound (sound |
| 31 | microphone | volume) |
| Alarm lamp 32 | Power-equipped photo | Illumination (flickering) |
| Direction indicator 33 | sensor | |
| Crosswalk emergency alarm | | |
| lamp (not shown) | | |
| Crossing rod 41 | Power-equipped | Acceleration of crossing rod |
| | accelerometer (XY axis: | Angle of crossing rod |
| | sensing driving and pressing, | Sensing vehicle body |
| | Z axis: sensing abnormal | (insertion of crossing rod) |
| | operation and breakage) | |
| | Power-equipped angle | |
| | (slope) sensor | |
| | Magnetic sensor | |
| Sensing vehicle body | Magnetic sensor (sensing | Distortion of magnetic field |
| | vehicle body, vehicle) | by vehicle body (sensing |
| | | entry of vehicle) |
| | | Identifying vehicle (sensing |
| | | passage of train) |

Data obtained by the sensor node group (sensor nodes SN11 to SN18) is transmitted to the controller node CN via the network 200 (direct wireless communication, hopping communication, wired line, etc.) and aggregated and retained in the controller node CN.

Each signal transmitted to the controller node CN is smoothened (by a short time peak hold/median filter). For example, the alarm lamp 32 is converted into a continuation signal (quantity of state), rather than relying on flickering of a flicker signal. Further, the flicker signal may be verified by observing ON/OFF continuation time or sensing a pitch (for example, 0.5 seconds) as necessary. Further, as described above, the smoothening may be performed in each of the sensor nodes SN11 to SN18 before each signal is transmitted to the controller node CN or may be performed in the controller node CN after each signal is transmitted to the controller node CN.

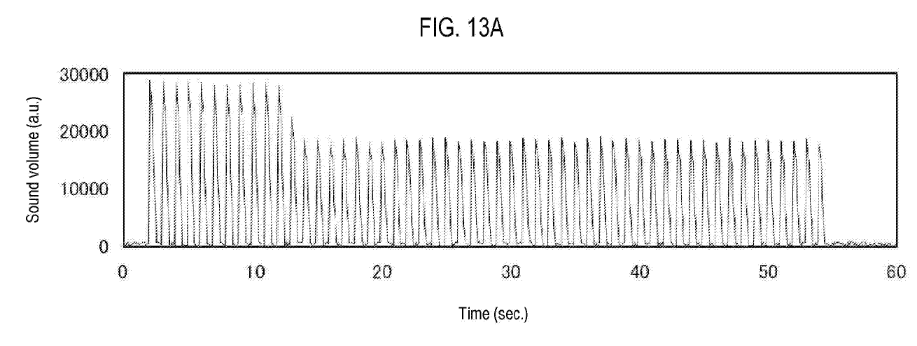

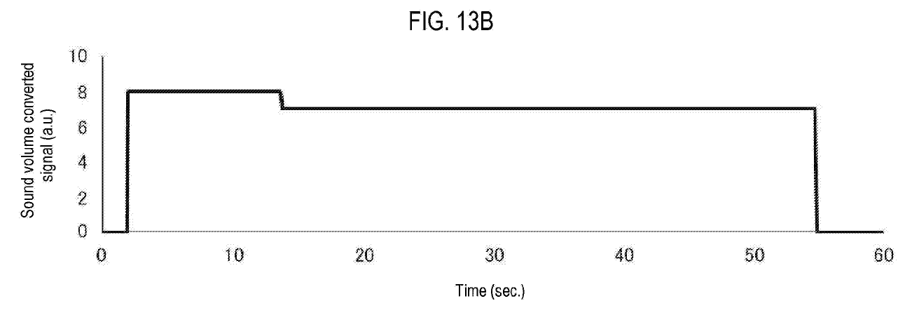

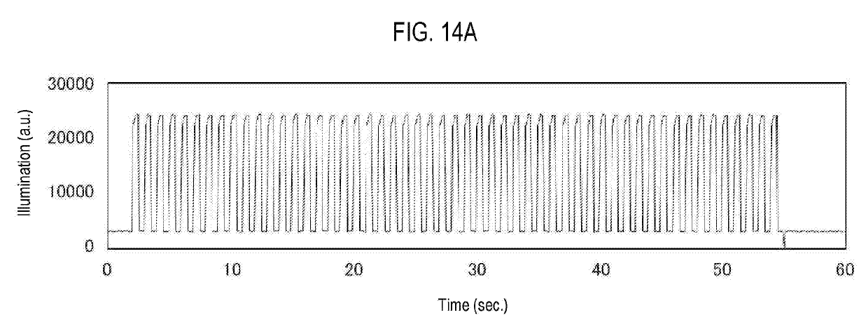

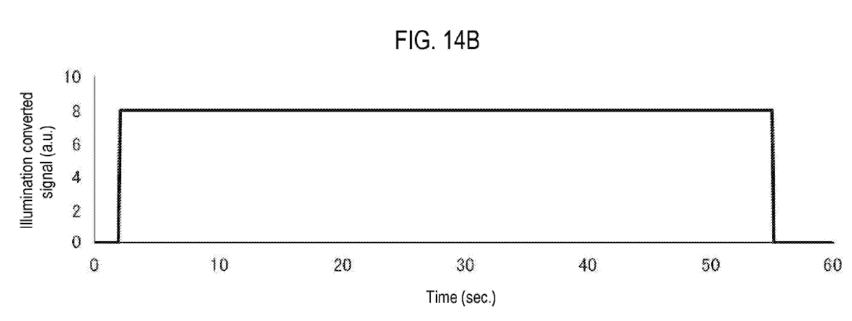

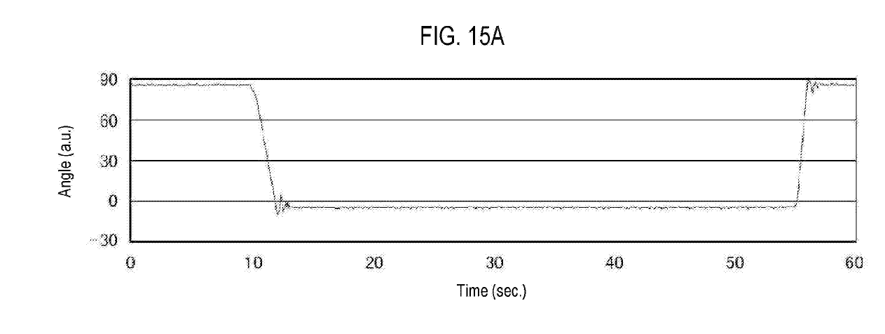

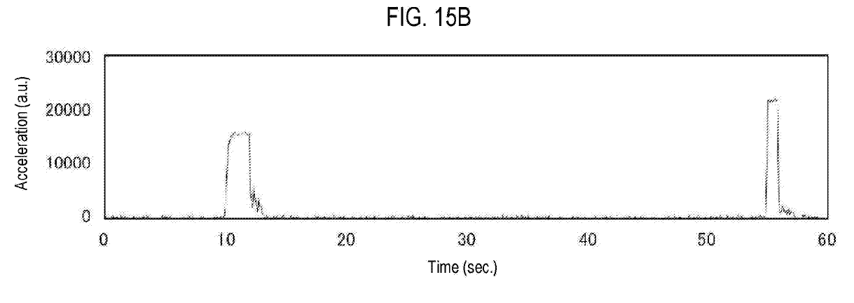

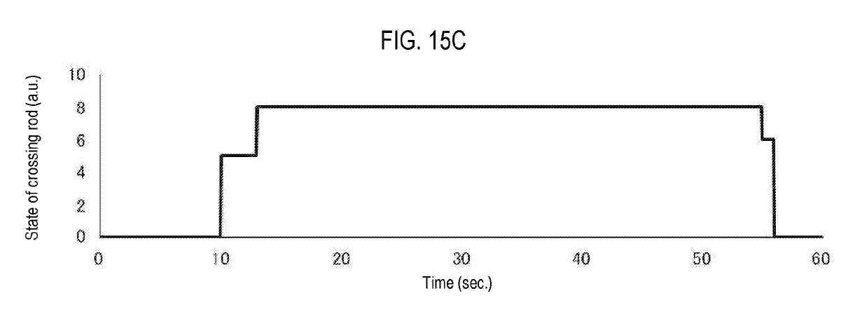

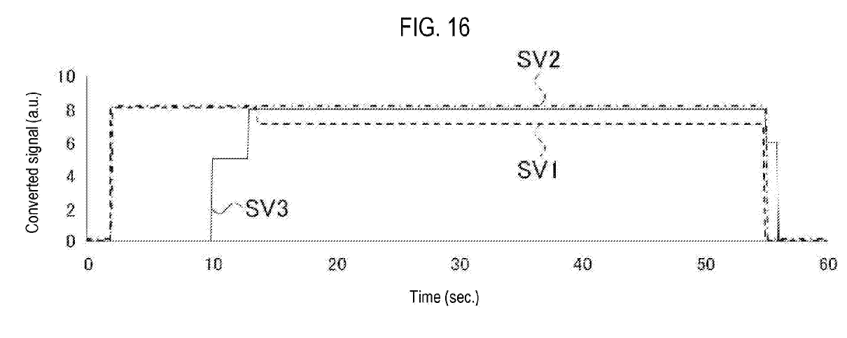

An example of time-series data of an original signal of sound volume data sensed by the sensor network system that is applied to the crosswalk monitoring system illustrated in FIG. 12 is schematically illustrated in FIG. 13A, and an example of data converted into a quantity of state by processing the original signal of FIG. 13A is schematically illustrated in FIG. 13B. An example of time-series data of an original signal of illumination data sensed by the sensor network system that is applied to the crosswalk monitoring system illustrated in FIG. 12 is schematically illustrated in FIG. 14A, and an example of data converted into a quantity of state by processing the original signal of FIG. 14A is schematically illustrated in FIG. 14B. An example of time-series data of an original signal of angle data sensed by the sensor network system that is applied to the crosswalk monitoring system illustrated in FIG. 12 is schematically illustrated in FIG. 15A, an example of time-series data of an original signal of acceleration data is schematically illustrated in FIG. 15B, and an example of data converted into a quantity of state by processing the original signals of FIGS. 15A and 15B is schematically illustrated in FIG. 15C. Further, an example of displaying the data converted into the quantity of state illustrated in FIGS. 13B, 14B, and 15C in an overlapping manner is schematically illustrated in FIG. 16. In FIG. 16, a smoothened waveform SV1 corresponds to a converted signal of the sound volume data illustrated in FIG. 13B, a smoothened waveform SV2 corresponds to a conversion signal of the illumination data illustrated in FIG. 14B, and a smoothened waveform SV3 corresponds to a converted signal of a state of the crossing rod illustrated in FIG. 15C.

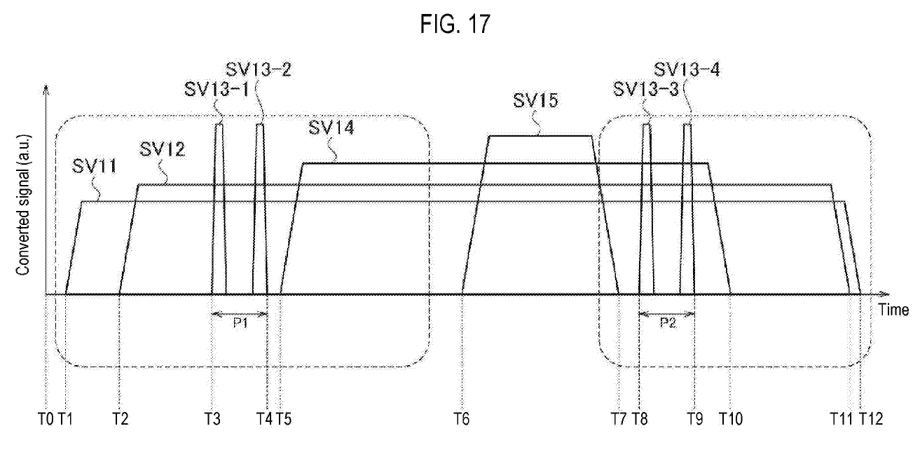

Further, an example of abstracting each data sensed by the sensor network system that is applied to the crosswalk monitoring system illustrated in FIG. 12 and displaying the same in an overlapping manner is schematically illustrated in FIG. 17.

As Illustrated in FIG. 17, at time T1, starting of flickering of the alarm lamp 32 and initiation of turning on the direction indicator 33 are started to be sensed by the sensor nodes SN12 and SN13, respectively (smoothened waveform SV11). Thereafter, at time T2, initiation of output of an alarm sound from the alarm generator 31 is started to be sensed by the sensor node SN11 (smoothened waveform SV12).

Further, during a period P1 from time T3 at which initiation of a closing operation of the crossing rod 41 is sensed by the integrated sensor node ISN3 (smoothened waveform SV13-1) to time T4 at which stop of the closing operation of the crossing rod 41 (closed state of the crossing rod 41) is sensed by the integrated senor node ISN3, the closing operation of the crossing rod 41 is continuously sensed.

After the crossing rod 41 is completely closed at the time T4, at time T5, starting of illumination of a crosswalk emergency alarm lamp (not shown) indicating entrance of a train to a vehicle driver or the like is started to be sensed by a photo sensor node (not shown) (smoothened waveform SV14).

Thereafter, at time T6, approach/passage of a train starts to be sensed by one or both of the sensor nodes SN17 and SN18, and the state where the train is passing is continuously sensed until completion of passage of the train is sensed by one or both of the sensor nodes SN17 and SN18 at time T7 (smoothened waveform SV15).

After the train has passed at the time T7, at time T8, starting of an opening operation of the crossing rod 41 is sensed by the integrated sensor node ISN3 (smoothened waveform SV13-3), and the opening operation of the crossing rod 41 is continuously sensed during a period P2 until stop of the opening operation of the crossing rod 41 (opened state of the crossing rod 41) is sensed by the integrated sensor node ISN3 at time T9 (smoothened waveform SV13-4). Further, in order to provide a time difference between the section from the times T6 to T7 and the operation of the crosswalk, a method of separately handling a decision vector or drifting a time axis in sensing at times T6 and T7 is used.

At time T10 after the crossing rod 41 is completely opened at the time T9, stop of illumination of the crosswalk emergency alarm lamp is sensed by a photo sensor node (not shown) (smoothened waveform SV14).

Thereafter, at time T11, stop of output of an alarm sound from the alarm generator 31 is sensed by the sensor node SN11 (smoothened waveform SV12). Also, at time T12, stop of flickering of the alarm lamp 32 and stop of turning on of the direction indicator 33 are sensed by the sensor nodes SN12 and SN13, respectively (smoothened waveform SV11).

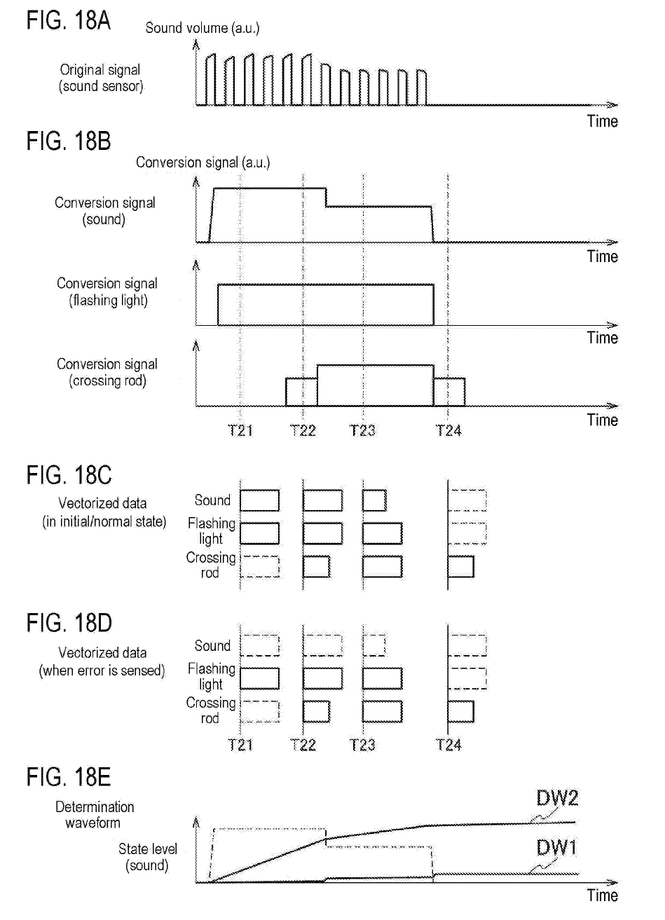

Here, an example of partial time-series data sensed by the sensor node SN11 as a part of the sensor network system illustrated in FIG. 12 is schematically illustrated in FIG. 18A, an example of data obtained by abstracting the time-series data illustrated in FIG. 18A is schematically illustrated FIG. 18B, an example of pre-stored time-series vectorized data in an initial/normal state is schematically illustrated in FIG. 18C, an example of data obtained by time-series vectorizing the abstracted data illustrated in FIG. 18B is schematically illustrated in FIG. 18D, and an example of determination waveforms for determining a state of the sensor target based on the time-series vectorized data illustrated in FIGS. 18C and 18D is schematically illustrated in FIG. 18E.

The calculation part 22 of the controller node CN vectorizes each abstracted time-series data illustrated in FIGS. 13B, 14B, 15C, 16, 17, and 18B at every time elapse (FIG. 18D), and compares the vectorized data with the vector data in the initial/normal state of the sensor target 2 (FIG. 18C), which is pre-stored in the memory part 24, at every time elapse. By accumulating residuals and monitoring a transition thereof, for example, it is possible to determine a state of the sensor target 2 (FIG. 18E).

For example, FIG. 18A illustrates a generated waveform of an alarm sound from the alarm generator 31 sensed by the sensor node SN11, and a waveform which is obtained by converting (smoothening) the waveform illustrated in FIG. 18A into a quantity of state by signal-processing (peak hold and quantization in the example of FIG. 18B) corresponds to the converted signal (sound) of FIG. 18B. Similarly, waveforms obtained by abstracting a generated waveform of a flashing light sensed by the sensor nodes SN12 and SN13 and a generated waveform of the crossing rod 41 sensed by the integrated sensor node ISN3 correspond to a converted signal (flashing light) and a converted signal (crossing rod) of FIG. 18B, respectively.

Further, a result of comparing the time-series vectorized data (sound) in the initial/normal state illustrated in FIG. 18C and the data (sound) obtained by time-series vectorizing the abstracted data illustrated in FIG. 18D at every time elapse corresponds to determination waveforms illustrated in FIG. 18E.

In FIG. 18E, a determination waveform DW2 corresponds to a case where a sound is not generated due to occurrence of an abnormality (a case where there is a difference with respect to pre-stored vectorized data at the initial/normal state), and a determination waveform DW1 corresponds to a normally operated case (close to the pre-stored vectorized data at the initial/normal state). In this example, since there is an abnormality (data loss) in the sound data at times T21, T22, and T23 of FIG. 18D, such a difference as illustrated in FIG. 18E occurs between the determination waveforms DW1 and DW2.

Here, an example of indices used in vector determination executed by the calculation part 22 of the controller node CN is illustrated using equations (1) to (5) below:

(1) Euclidean distance form

$${d}^{2} = {\sum }_{i = 1}^{n} {{a}_{i} ( {x}_{i} - {\hat{x}}_{i} )}^{2} \qquad Eq . ( 1 )$$

where d² is an index, a, is a weighted factor, xᵢ is a signal, and \hat{x}ᵢ is a predictive value (normal value).

(2) Two square form

$$d = {\sum }_{i = 1}^{n} {{a}_{i} ( {x}_{i} - {\hat{x}}_{i} )}^{2} \qquad Eq . ( 2 )$$

(3) Manhattan distance form

$$d = {\sum }_{i = 1}^{n} {a}_{i} \vert {x}_{i} - {\hat{x}}_{i} \vert \qquad Eq . ( 3 )$$

(4) Chebychev distance form

$$d = {max}_{i} ( {a}_{i} \vert {x}_{i} - {\hat{x}}_{i} \vert ) \qquad Eq . ( 4 )$$

(5) Inner product

$$d = cos θ = \frac{{\sum }_{i}^{n} {x}_{i} {\hat{x}}_{i}}{\sqrt{{\sum }_{i = 1}^{n} {x}_{i}^{2}} \sqrt{{\sum }_{i = 1}^{n} {\hat{x}}_{i}^{2}}} \qquad Eq . ( 5 )$$

where d is an index and θ is an angle of vectors.

As in the present embodiment, for a signal having a time-series pattern with high regularity, determination may be made on an obtained time-series pattern and a pattern at the time of initial/normal operation. However, in case of a signal with low regularity, extraction of a plurality of vectors that can be obtained in a normal time (reference vector group), vector-comparison between the latest vector and all of the reference vector group, and normal/abnormal determination with the nearest reference vector may be performed.

This will be described using the data of the present embodiment. That is, the reference vector (flickering, sound, crossing rod) are given by b1.(0,0,0), b2.(8,8,0), b3.(8,8,5), b4.(8,8,8), b5.(8,7,8), and b6.(0,0,6). For example, as illustrated in FIG. 18D, in a case where data of the alarm generator 31 (sound) at the times T21, T22, and T23 has an abnormality (for example, fault), a vector of the signal transitions to s1.(0,0,0), s2.(8,0,0), s3.(8,0,5), s4.(8,0,8), s5.(8,0,8), s6.(0,0,6), and s7.(0,0,0) in time-series order. Based on this, in a case where a determination is made in the Manhattan distance without a weighted value, for example, a distance to the reference vector from s2 is sequentially 8,8,13,16,15, and 14 from b1 to b6, and in this case, the nearest vector is b1 or b2 (original comparison target) and a residual is 8. Similarly, since it can be known that a distance from s3 is 13,13,8,11,10, and 9, b3 is the nearest, and a residual is as large as 8, a discrepancy from the normal, namely, abnormality can be determined.

As mentioned above, according to the present embodiment, it is possible to provide a sensor node, a controller node, a sensor network system, and an operation method thereof, which are capable of easily and accurately determining abnormality in a time-series event, by using an algorithm with a small amount of calculation, in a sensor network system having a plurality of sensors such as a smart sensor and a sensor fusion.

### OTHER EMBODIMENTS

As described above, although the embodiments have been described, the description and drawings constituting part of the present disclosure are merely illustrative and should not be understood to be limiting. Various alternative embodiments, examples, and operating techniques will be apparent to those skilled in the art from the present disclosure.

Thus, the present disclose includes a variety of embodiments and the like that are not disclosed herein.

The sensor network system of the present disclosure can be applicable to infrastructure monitoring of various constructions such as a bridge, a road, a railroad, a building, and the like. Further, not limited to the constructions, the sensor network system may be applicable to various fields such as air pollution, forest fire, wine brewing quality management, care of children who plays in the field, care of people who play a sport, detection of a smart phone, peripheral access control to a nuclear power plant or a defense facility, detection of a radioactivity level in a nuclear power plant, strength level control of electromagnetic field, recognition of a traffic jam situation such as traffic congestion, smart road, smart lighting, high-functional shopping, a noise environment map, highly efficient shipment of a ship, water quality management, waste treatment management, smart parking, golf course management, water leakage and gas leakage management, automatic driving management, effective infrastructure arrangement and management in an urban area, and a farm.

Further, in the sensor network system according to the present disclosure, the sensor target is an interpersonal notification signal and a light installed in various constructions or the like as mentioned above. Here, the interpersonal notification signal includes a crosswalk or railroad signal (signal for a railroad, a crossing barrier, etc.), a road signal (a signal light, etc.), an aviation signal (airplane warning light, aerodrome light, etc.), and a marine signal (a floating light, a beacon light (navigational aids), etc.). Further, the light includes a standing light, an emergency exit light, an emergency light, a street light, etc.

According to some embodiments of the present disclosure in, it is possible to provide a sensor node, a controller node, a sensor network system, and an operation method thereof, which are capable of easily and accurately determining abnormality in a time-series event, by using an algorithm with a small amount of calculation, in a sensor network system having a plurality of sensors such as a smart sensor and a sensor fusion.

While certain embodiments have been described, these embodiments have been presented by way of example only, and are not intended to limit the scope of the disclosures. Indeed, the novel methods and apparatuses described herein may be embodied in a variety of other forms; furthermore, various omissions, substitutions and changes in the form of the embodiments described herein may be made without departing from the spirit of the disclosures. The accompanying claims and their equivalents are intended to cover such forms or modifications as would fall within the scope and spirit of the disclosures.

What is claimed is:

1. A sensor node, comprising:
a sensor part configured to sense information from a sensor target;
a calculation part configured to digitize at least one data of a portion or all of the sensed sensor information and calculate the digitized data to abstracted data indicating a quantity of state; and
an internal communication part configured to transmit the abstracted data to a controller node via a network.

2. The sensor node of claim 1, wherein the sensor part comprises a plural number of or a plural type of sensor elements, or a plural number of and a plural type of sensor elements.

3. The sensor node of claim 2, wherein the sensor elements are one or more sensor elements for sound, illumination, angle, acceleration, and magnetism.

4. The sensor node of claim 1, wherein a plural type of abstracted data is generated for each sensing event.

5. The sensor node of claim 1, wherein the calculation part is configured to generate the at least one data of the sensed sensor information in time series.

6. The sensor node of claim 1, further comprising a power supply part configured to supply an electric power to the sensor node.

7. The sensor node of claim 6, wherein the power supply part includes any one or both of a battery and a power generation device.

8. The sensor node of claim 1, wherein the network is a wireless communication network.

9. The sensor node of claim 1, wherein a process of calculating the digitized data to the abstracted data includes a smoothing process.

10. The sensor node of claim 1, wherein the sensor target includes any one or both of an interpersonal notification signal and a light.

11. A controller node, comprising:
a memory part configured to store vector data in an initial state or normal state of a sensor target in advance;
an internal communication part configured to receive abstracted data, which is obtained by abstracting sensing data from the sensor target and individually transmitted from a plurality of sensor nodes, via a network; and
a calculation part configured to determine a state of the sensor target by converting the received abstracted data into vector data and performing comparison and calculation on the converted vector data with the vector data in the initial state or normal state stored in the memory part.

12. The controller node of claim 11, wherein the internal communication part is configured to receive the sensing data of the sensor target before abstraction from at least one of the plurality of sensor nodes, and
the calculation part is configured to calculate the received sensing data to abstracted data indicating a quantity of state.

13. The controller node of claim 11, wherein a plural type of vector data is generated for each sensing event by the sensor nodes.

14. The controller node of claim 11, wherein the calculation part is configured to generate at least one data of the vector data in time series.

15. The controller node of claim 11, further comprising a power supply part configured to supply an electric power to the controller node.

16. The controller node of claim 15, wherein the power supply part includes any one or both of a battery and a power generation device.

17. The controller node of claim 11, wherein the network is a wireless communication network.

18. The controller node of claim 11, wherein the comparison and calculation includes at least one of an accumulated norm and an inner product of deviation vectors.

19. The controller node of claim 11, wherein the sensor target includes any one or both of an interpersonal notification signal and a light.

20. The controller node of claim 11, further comprising an external communication part configured to notify a predetermined destination about the state of the sensor target determined by the calculation part.

21. A sensor network system, comprising:
a plurality of sensor nodes; and
a controller node,
wherein each of the plurality of sensor nodes includes:
a sensor part configured to sense information from a sensor target;
a calculation part configured to digitize at least one data of a portion or all of the sensed sensor information and calculate the digitized data to abstracted data indicating a quantity of state; and
an internal communication part configured to transmit the abstracted data to the controller node via a network, and
wherein the controller node includes:
a memory part configured to store vector data in an initial state or normal state of the sensor target in advance;
an internal communication part configured to receive the abstracted data individually transmitted from the plurality of sensor nodes via the network; and
a calculation part configured to determine a state of the sensor target by converting the received abstracted data into vector data and performing comparison and calculation on the converted vector data with the vector data in the initial state or normal state stored in the memory part.

22. The system of claim 21, wherein the network is a wireless communication network.

23. The system of claim 21, wherein a plural type of vector data is generated for each sensing event by the sensor nodes.

24. The system of claim 21, wherein the sensor elements are one or more sensor elements for sound, illumination, angle, acceleration, and magnetism.

25. A method of operating a sensor network system, comprising:
at a plurality of sensor nodes, sensing sensor information from a sensor target;
at the plurality of sensor nodes, digitizing at least one data of a portion or all of the sensed sensor information and calculating the digitized data to abstracted data indicating a quantity of state;
at the plurality of sensor nodes, transmitting the abstracted data to a controller node via a network;
at the controller node, receiving the abstracted data individually transmitted from the plurality of sensor nodes via the network; and
at the controller node, determining a state of the sensor target by converting the received abstracted data into vector data and performing comparison and calculation on the converted vector data with vector data in an initial state or normal state of the sensor target that is pre-stored in a memory part.
